(19) United States
(12) Patent Application Publication
(10) Pub. No.: US 2014/0362177 A1
(43) Pub. Date: Dec. 11, 2014

(54) METHOD AND DEVICE FOR CONTROLLING A MOTION-COMPENSATING MIRROR FOR A ROTATING CAMERA

(71) Applicant: Logos Technologies LLC, Fairfax, VA (US)

(72) Inventor: Murray Dunn, Encinitas, CA (US)

(21) Appl. No.: 14/366,100

(22) PCT Filed: Jan. 11, 2013
(86) PCT No.: PCT/US2013/021222

§ 371 Date: Jun. 17, 2014

Related U.S. Application Data
(60) Provisional application No. 61/586,432, filed on Jan. 13, 2012.

(51) Int. Cl. G03B 17/17; G08B 13/196; G03B 37/02

(52) U.S. Cl. CPC G03B 17/17; G03B 37/02; G08B 13/19628; G08B 13/1963; G08B 13/19632
USPC 348/37

(57) ABSTRACT

A scanning imaging apparatus including a rotatable support platform, an imaging device that is attached to the support platform; a mirror that is rotatably attached to the support platform and is configured to deflect an optical path of the imaging device; a first motor configured to continuously rotate the rotatable support platform at a first angular velocity; a second motor configured to change an angle of the mirror relative to an optical axis of the imaging device at a second relative angular velocity relative to the optical axis; and a controller configured to control the angle of the mirror so that a waveform of the angle of the mirror as a function of time does not have high frequency components.

### FIELD OF THE INVENTION

The present invention relates generally to methods and devices for controlling a scanning mirror for a moving or rotating camera with the purpose of stabilizing the captured image by compensating for the rotation by the scanning mirror.

### BACKGROUND OF THE INVENTION

In imaging surveillance systems, usually high resolution images are generated from a scenery by rotating a camera with an image sensor or focal plane array, and by capturing images during the rotation from different view angles. These individual images can be merged together to form a high-resolution panoramic image of the scenery. However, as the camera is rotated to capture images from different angles of the scenery, the field of view of the pixels does not remain constant due to the rotation, and the integration time for light of the image sensor or focal plane array is often not fast enough to avoid substantial blurring of the image. Often, the distance moved by the camera is of the order of several pixels during an integration. Therefore, a system is needed that can efficiently compensate the rotational movement of the camera to capture images with no or substantially less blurring.

### SUMMARY OF THE EMBODIMENTS OF THE INVENTION

One aspect of the present invention provides for a scanning imaging apparatus. The scanning imaging apparatus preferably includes a rotatable support platform, and an imaging device that is attached to the support platform. Moreover, the scanning imaging apparatus further preferably includes a mirror that is rotatably attached to the support platform and is configured to deflect an optical path of the imaging device, a first motor configured to continuously rotate the rotatable support platform at a first angular velocity, and a second motor configured to change an angle of the mirror relative to an optical axis of the imaging device at a second relative angular velocity relative to the optical. Moreover, the scanning imaging apparatus also preferably includes a controller configured to control the angle of the mirror so that a waveform of the angle of the mirror as a function of time does not have high frequency components.

According to another aspect of the present invention a rotating camera system is provided. The rotating camera system preferable includes a first motor, a camera forming an optical axis, the camera being rotatable by the first motor, and a mirror arranged in a path formed by the optical axis configured to reflect the optical axis of the camera to form a reflected optical axis. Moreover, the rotating camera system further preferably includes a second positional motor that is connected to mirror for changing a relative angle between the optical axis of the camera and the reflected optical axis, and a controller configured to control the relative angle so that a waveform of the relative angle as a function of time does not have high frequency components.

### BRIEF DESCRIPTION OF THE SEVERAL VIEWS OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a diagrammatic schematic side view of a rotating optical assembly having a scanning mirror, according to one embodiment of the present invention;

FIGS. 2a-2g are schematic top views of the rotating optical assembly showing the control of the scanning mirror step-by-step in during an image acquisition and readout period;

FIG. 3 is a graph representing waveforms of angular positions α and γ, angular velocities Ω and ω, and angular acceleration dω/dt according to one embodiment of the present invention;

FIG. 4 shows waveform approximations that can be used to define the relative angular position α of scanning mirror according to another embodiment;

FIG. 5 is a schematic representation of a control system for the rotating optical assembly; and

FIG. 6 is a graph representing waveforms of angular position α, angular velocity ω, and angular acceleration dω/dt according to the background art.

Herein, identical reference numerals are used, where possible, to designate identical elements that are common to the figures. Also, the images in the drawings are simplified for illustration purposes and may not be depicted to scale.

### DETAILED DESCRIPTION OF THE PREFERRED EMBODIMENTS

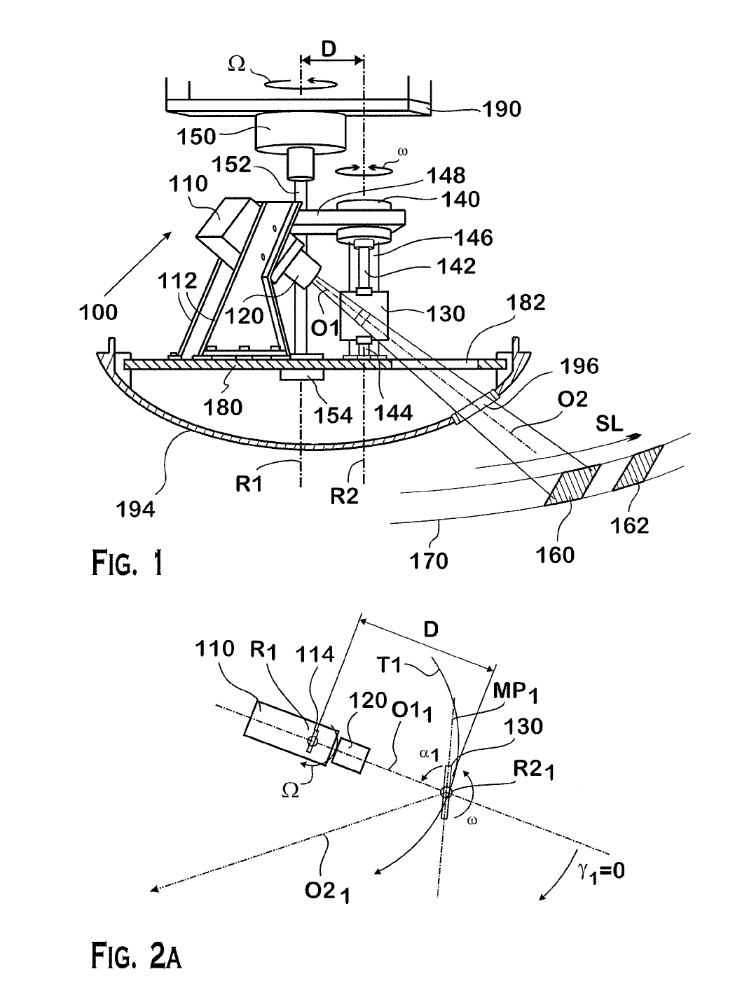

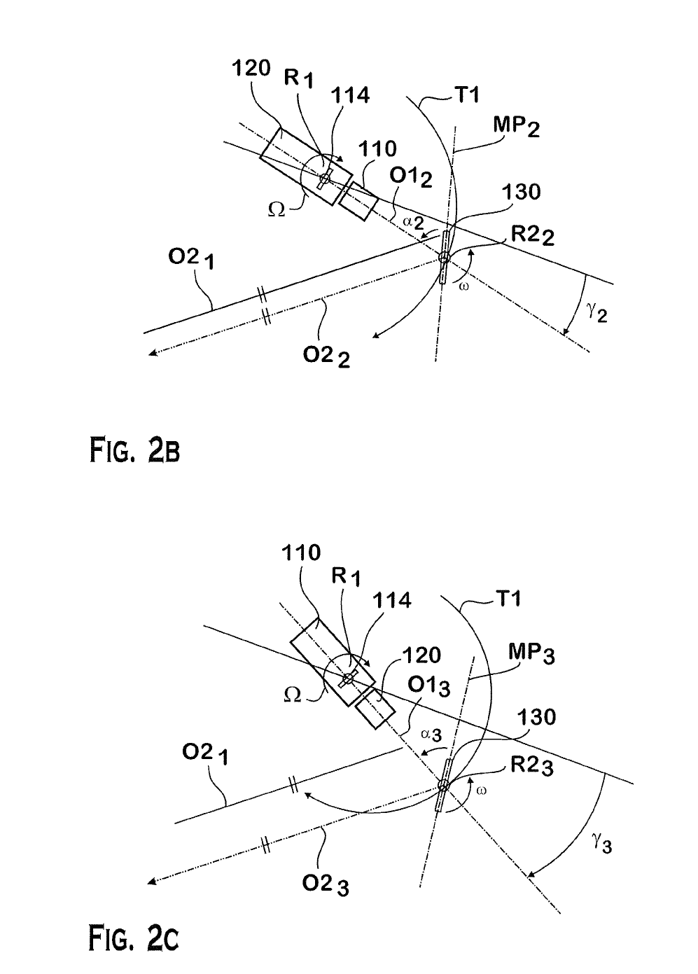

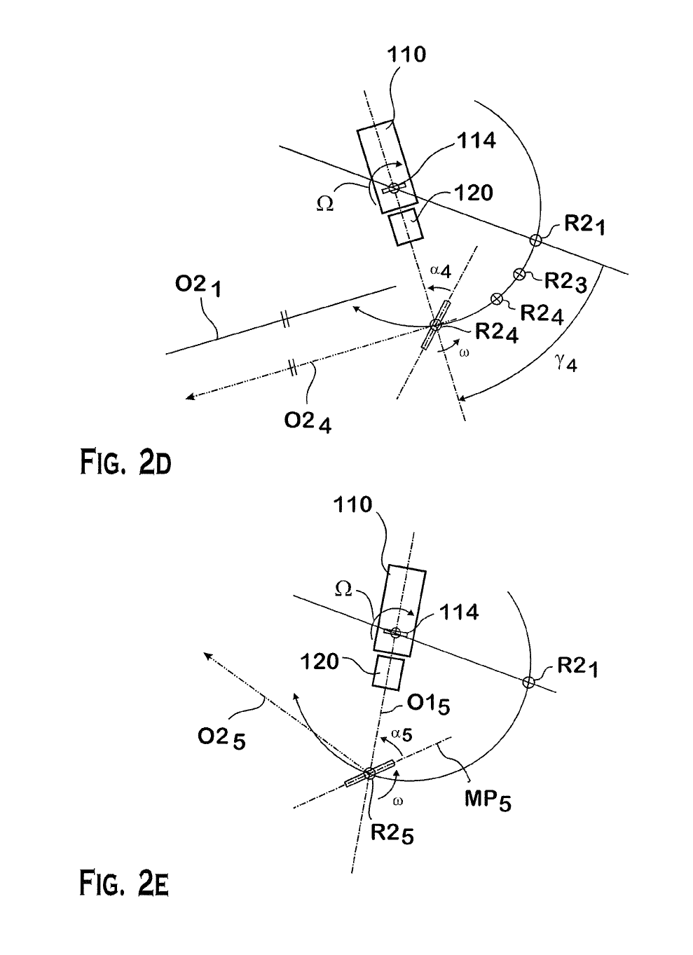

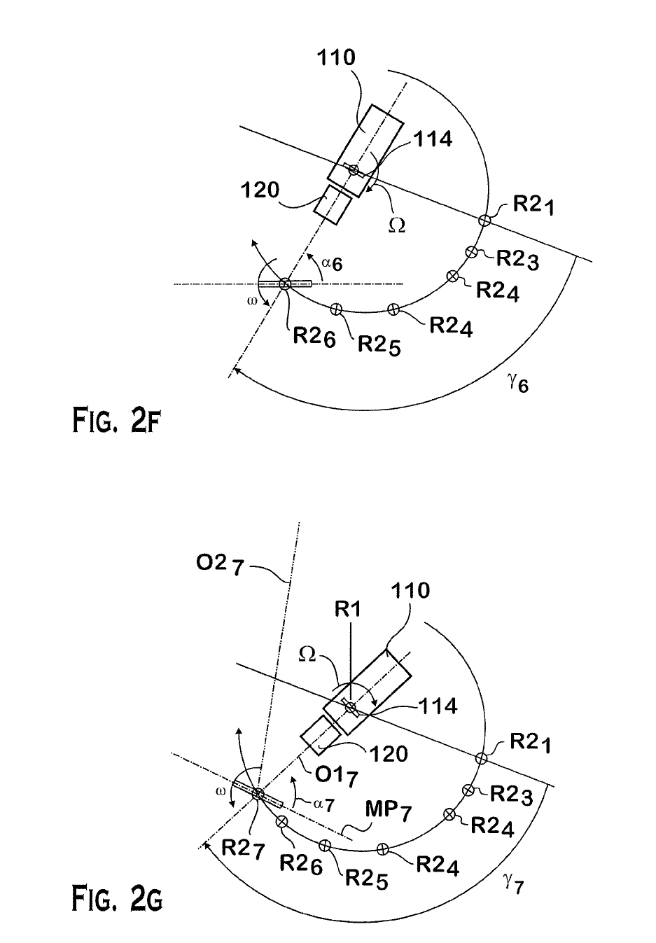

FIG. 1 depicts a diagrammatical schematic side view of a rotating optical assembly 100 having an imaging device 110 such as a camera with lens 120 that form optical axis O1, for example a gimbal that can rotate about rotational axis R1. Camera 110 is mounted to a rotatable disk 180 via a fixation device 112, for example a mounting bracket or tripod. Camera 110 preferably uses a two-dimensional image sensor, but line scan cameras can also be used for the present invention. Also, camera 110 includes an images sensor 114 (FIGS. 2a-2g) such as a complementary metal oxide semiconductor (CMOS) sensor, a charge coupled device (CCD) sensor, focal plane arrays (FPA) for infrared imaging, etc. that usually uses an image acquisition time period where the pixels of the sensor are exposed to light to capture an image, and an image readout period during which data of the pixels are acquired by a controller from the pixels, so that the data can be stored in a memory. Disk 180 is rotated about rotational axis R1 by first motor 150 having a motor shaft 152 that is attached to a platform 190. Platform 190 can be attached to an aircraft as a payload (not shown), for example an aerostat or a surveillance aircraft drone. Platform 190 may also be connected to a mechanical device that compensates for transversal motion of platform due to aircraft vibration or movement, such as a shock absorbing interface (not shown) having active or passive shock absorbing characteristics. First motor 150 that rotates disk 180 is mechanically connected to disk 180 via motor shaft 152 and an attachment nut 154 that is located in the center of disk 180 rotating about the rotational axis R1. First motor 150 usually rotates with angular velocity Ω between 10 full rotations per second (angular velocity 20π in rad/sec) and 0.2 full rotations per second (angular velocity of 2π/5 in rad/sec) so that camera 110 can capture multiple images along one rotation of disk 180. For example, if the image capture frequency of camera 110 is f=50 Hz, and the rotational speed or angular velocity Ω is 6π (corresponding to 3 Hz), 150 images will be captured along scene 170 in a 360° rotation of camera 110. A power supply (not shown) feeds first motor 150 with the necessary electrical energy for rotation, and a controller (not shown) delivers control signals to first motor 150 to maintain the angular velocity Ω.

Moreover, FIG. 1 shows a second motor 140 is attached to disk 180 by an installation bar 146 and also attached to mounting bracket 112 with a holder 148 to provide a rigid mechanical installation of camera 110, second motor 140, and scanning mirror 130, to preserve the geometrical arrangement of these elements. Second motor 140 has a rotational axis R2 that is parallel to the rotational axis R1, but located at a radius D away from the rotational axis R1 of disk 180. Second motor 140 is configured to rotate with angular velocity w change an angular position of a scanning mirror 130 while disk 180 is rotated by first motor 150, so that mirror 130 and first motor 140 act as a galvanometer. Scanning mirror 130 is moved by second motor 140 via a shaft 142 that is attached to an upper edge of scanning mirror 130, and a lower bar 144 can also be rotatably attached to disk 180 to mechanically stabilize scanning mirror 130. Scanning mirror 130 is located in the optical path O1 of camera 110 and lens 120, and in the variant shown, optical path O1 is reflected to form a second optical path O2 as the main scanning path. Opening 182 is arranged in disk 180 so that optical path O2, and a viewing window 196 with light filtering characteristics is arranged such that the optical path O2 traverses the window 196. Window 196 is formed in a protective outer cover 194 that is installed such that it rotates with disk 180.

With the rotation of disk 180 and the camera view that is redirected towards a scene 170 by scanning mirror 130 via optical paths O1 to O2, camera 110 can capture images 160, 162 at repeating moments during rotation to scan scene 170, so that a panoramic 360° degree view can be later generated from consecutive images 160, 162. Unlike the first motor 150 that usually only rotates in one direction, for example a continuous counter-clockwise rotation around rotational axis R2 with angular velocity Ω as shown in FIG. 1, the second motor 140 can rotate with angular velocity ω back and forth, clockwise and counter-clockwise, around rotational axis R2. Also, second motor 140 does not have to perform full rotations, but has to be able to change the angular position of scanning mirror 130 relative to disk 180 to cover a certain angular range, for example by using a stepper motor or a positional motor that can cover less than 90° degrees. For example, the relative angular position a that is defined by a plane MP formed by the extension of the scanning mirror 130 surface, and the optical axis O1 of camera 110 and lens 120, needs to be variable by using second motor 140. Therefore, for descriptive purposes, optical axis O1 of camera 110 that is rotating can be said to form an axis of a rotating coordinate system with respect to the definition of relative angular position α of mirror 130.

The scanning mirror 130 is actuated by second motor 140 so as to compensate for the rotation of camera 110 and lens 120 by first motor 150 during a time an image is acquired by camera 110 by a counter-rotation. Therefore, the rotational axes R1 of first motor 150 and R2 of second motor 140 are substantially parallel, and during image capture of camera 110, second motor 140 rotates mirror 130 counter the rotation of first motor 150 at substantially the same rotational speed, so that ω corresponds to −Ω (negative Ω) within a certain tolerance. For example, while camera 110 is capturing an image 160 of scene 170 and at the same time camera 110 is rotated by first motor 150 by angular velocity Ω, mirror 130 is counter-rotated by second motor 140 with a angular velocity ω that is the same or substantially similar to angular velocity Ω of first motor 150. This counter-rotation during image capture allows to stabilize the reflected optical axis O2 to be oriented towards the same direction during the capturing of image 160 regardless of rotation Ω of camera 110. Next, when an adjacent image 162 is captured from scene 170, the scanning mirror 130 is repositioned by second motor 140 to direct second optical axis O2 towards a new position on the scene 170 to capture image 162, and the second optical axis O2 is again stabilized to the same direction O2 by the counter-rotation. This movement of scanning mirror 130 is repeated for each capturing of a subsequent image along the scene 170 to minimize motion blur on the image that would result from rotation of camera 110 during image capture with angular velocity Ω. Consecutively captured images 160, 162 may be entirely separate from each other, may be bordering each other closely, or may also overlap, depending on angular velocity Ω, image capturing frequency f of camera 110, and the width of the field of view generated by camera 110 and optics 120.

In particular, the second motor 140 that positions scanning mirror 130 is controlled such that scanning mirror 130 is moved to stabilize optical axis O2 to a direction that is present at the start of an image integration by image sensor 114 of camera 110, and this direction is maintained until the image integration is completed, and no more image data is captured for the present frame. Ideally, and as explained above, the relative angular position α is linearly decreased by angular velocity ω to counter the linear increase of absolute angular position γ. Next, instead of abruptly and rapidly moving back scanning mirror 130 to the initial angular position for the next image capture, scanning mirror 130 is moved back in a sine-like waveform, and in the variant shown, without any angular accelerations dω/dt above a certain threshold, and without exceeding a maximal angular velocity Ωₘₐₓ for the relative angular position α after the image integration in camera 110 has ended. The time period for moving back the scanning mirror to a new image capturing position includes at least the time all the pixel values from the matrix of the image sensor 114 is read out. This is different from background scanning systems, in which a scanning mirror snaps back immediately, as shown in the waveforms represented in FIG. 6, depicting relative angular position a, do) angular velocity ω, and angular acceleration dω/dt that may be extremely high. Also, such waveform as shown on the top in FIG. 6 has high-frequency components.

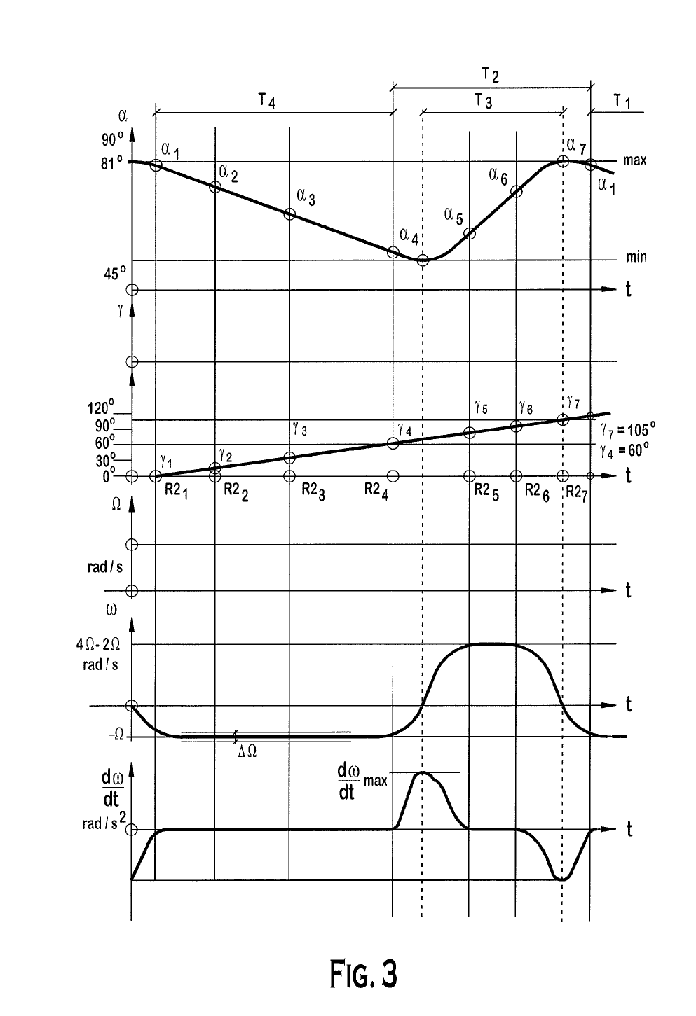

However, as shown in FIG. 3, the waveform that is used for the relative angular position α does not have any high frequency components. For example, preferably the waveform signal for a does not have any frequency components that are above eleven (11) times the fundamental frequency f, and more preferably does not have any frequency components that are above nine (9) times the fundamental frequency f. Frequency f is also the image capturing frame rate of camera 110, since the waveform for α needs to be periodic with the image acquisition. In a variant, it is also possible to limit the angular accelerations dω/dt of the relative angular position α to be below a certain threshold value dω/dtmax since high angular accelerations require torque and therefore a more powerful second motor 140. Preferably, the angular accelerations dω/dt are limited to be below 11 ω/s², more preferably below 9 ω/s². Also, in another variant, rotational speed ω of the relative angular position α never exceeds a maximal angular velocity ωₘₐₓ, preferably being six (6) times angular velocity Ω generated by motor 150, more preferably rotational speed ω never exceeds three (3) times angular velocity Ω. Thereby, a dead time during which camera 110 cannot be used to capture images is instead usable to move back scanning mirror 130 without any abrupt movements having high frequency content.

The above described control method of the scanning mirror presents many advantages. For example, rotating optical assembly 100 for low-light surveillance systems often uses cameras 110 having image sensors 114 with a very high sensitivity to be able to capture valuable images at low light. Such image sensors 114 usually operate without a pixel-based electronic shutter mechanism, and also have a high pixel fill factor, so that high pixel sensitivity is guaranteed. In light of the architecture of these image sensors, it may not possible to integrate a new image while the previous image has not yet been read out, and therefore a dead time between two successive image integrations tends to be longer. Therefore, the increased duration of the dead time as compared to some less sensitive image sensors, such as interline image transfer sensors, can be used to move back scanning mirror 130 to its initial position for the next image capture without the need of a fast and powerful motor that allows very fast angular speeds and accelerations, and at the same time, the image acquisition process from camera 110 is not delayed.

Also, such abrupt movement of the scanning mirror 130 has several disadvantages. First, when a scanning mirror is snapped back rapidly to an image capturing position, the motor positioning the scanning mirror is subject to very high forces due to the inertia of the mirror, and therefore would require a more powerful motor that may be heavier, more expensive, more voluminous, and require more power. For example, an exemplary scanning mirror 130 may have a size of 10 cm to 10 cm, a thickness of 5 mm with a weight of 100 grams, thereby having a moment of inertia that would require an motor with substantial torque for high angular accelerations to move a scanning mirror. In addition, the rapid acceleration on scanning mirror can also cause the mirror to be subject to bending forces and mechanical oscillations that could impact the image quality of images 160, 162 captured by camera 110, even if scanning mirror 130 stabilizes optical axis O2. These mechanical oscillations and forces can also be the cause of rapid aging of the materials shortening the lifetime of the system.

In addition, because second motor 140 and scanning mirror 130 are usually not located in the rotational axis R1, but offset by a radius D, it is important to keep mirror 130 and motor 140 as light weight as possible, to avoid additional weight to compensate for the unequal weight distribution around rotational axis R1 on disk 180. Depending on the angular velocity of rotation Ω, additional weights would have to be added to create an axi-symmetrical weight distribution. Overall this leads to a smaller and lighter design of the rotating optical assembly 100. Also, in combination with the smaller motor 140, to reduce the size of scanning mirror 130, mirror 130 is located in close proximity to the lens of the camera, to keep the size of mirror 130 as small as possible.

As shown with respect to FIGS. 2a to 2g, different positions of scanning mirror 130, camera 110, image sensor 114 is shown, for example by representing relative angular position α of scanning mirror 130 relative to the optical axis O1 of camera 110 and lens 120, for the rotating optical assembly 100. For simplicity purposes, camera 110 is shown such that it rotates around a rotational axis R1 that crosses through the focal plane defined by image sensor 114 of camera 110, but any position of rotational axes R1 and R2, as long as optically feasible, is also applicable to the description below.

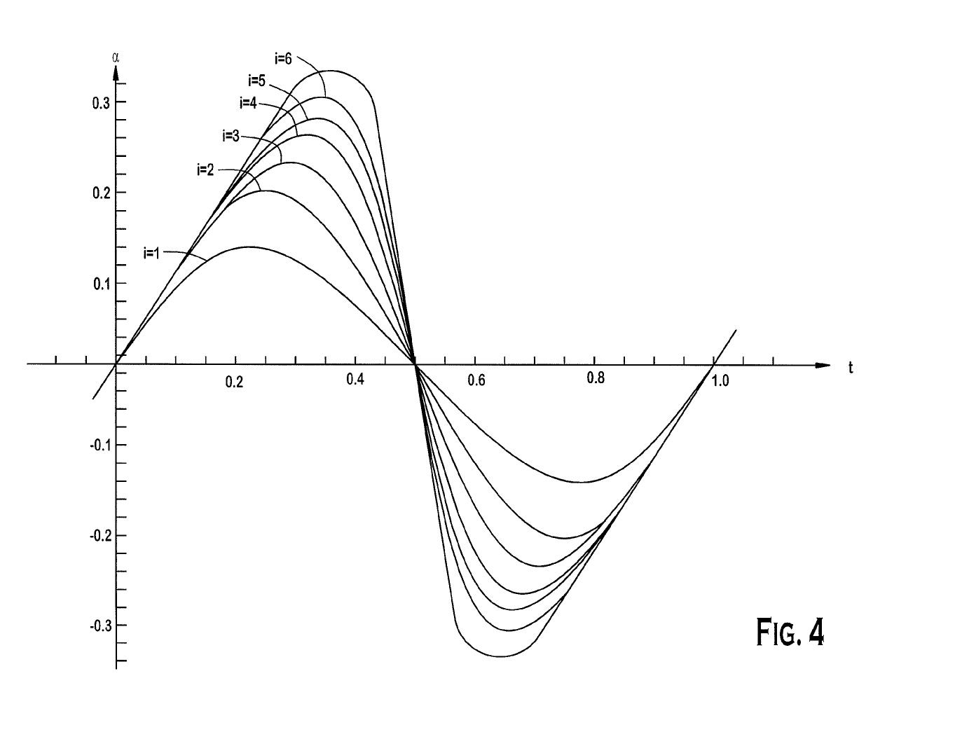

As explained above, instead of instantaneously or very rapidly snapping back the scanning mirror 130 to a start position with start angle α₁ for the scanning for every image integration cycle, relative angular position α of scanning mirror 130 is moved with an approximation of a sawtooth or triangular signal that is composed of a fundamental sine wave and additional higher order harmonics. An example of an definition of such waveform is given below with respect to FIGS. 3 and 4. Thereby, instead of resetting the mirror instantaneously back to the initial position, the mirror is moved back more harmonically and slower during a time where no images are captured, and no rapid angular velocities accelerations occur. This movement waveform of the mirror 130 allows to keep the field of view constant despite the rotation/scanning of apparatus 100, and at the same time can avoid any rapid positional changes of the scanning mirror 130, so the position of scanning mirror 130 can be controlled with a higher precision using a smaller, lighter and less powerful design of second motor 140.

With respect to FIG. 2a, camera 110 and lens 120 is shown at an initial position when camera 110 is rotating with a constant angular velocity Ω clockwise and starts the image acquisition process for a duration T₁. Camera 110 is equipped with image sensor 114 and together with lens 120 define first optical axis O1₁. Light along optical axis O1₁ is reflected on mirror 130 to form optical axis O2₁. With respect to optical axis O1₁, mirror 130 is located at an initial relative angular position α₁ and this angle is substantially linearly decreased, and mirror 130 is being turned counter-clock wise to counter rotation Ω. The initial angular position of disk 180 is indicated with γ₁. The rotational axis R2 will move around R1 in a radius D, and the initial position is labeled as R2₁.

FIGS. 2b and 2c, show the positions of camera 110 and mirror 130 while the image sensor 114 is acquiring a single image, while FIG. 2d shows the position of camera 110 and mirror 130 when the acquisition of the single image ends. During this time, the optical axis changes its position from O2₁ to O2₂, O2₃, and O2₄ but their direction remains parallel to the initial position O2₁ so that the same image 160 of scene 170 is exposed to image sensor 114 of camera. Due to the rotation of camera 110 around axis R1, rotational axis of mirror 130 changes along a circular line from R2₁ to R2₂, R2₃, and R2₄. The relative angular position α₁ of mirror 130 with respect to optical axis O1 decreases substantially linearly from α₁ to α₂, α₃, and α₄, thereby steadily decreasing to maintain the parallelism to the initial position of the second optical axis O2₁. Also, angular position of disk changed from initial position γ₁ to γ₂, γ₃, and γ₄.

FIGS. 2e and 2f shows positions of the camera 110 and mirror 130 after the first image 160 has been captured by the pixels of image sensor 114 of camera 110, and preferably, the data of image sensor 114 is being read out, and no new image is acquired yet, because mirror 130 has not yet been brought back to a scanning position. The relative angular position α of mirror is increased again from α₄ to α₅ and α₆, to bring the mirror continuously back to the maximal relative angular position α₇.

With respect to FIGS. 2a to 2f, the angles α and γ and geometric relationships shown are provided for explanatory purposed only, and it appears that for capturing one image the camera 110 is rotated about γ₄=60° so that the change in the angles can be easily visualized. Although such variant is also within the scope of the present invention, more commonly, since it is possible that many more images be captured during one rotation, for example 50 or 100 images, in most embodiments the changes to angle α would be much smaller.

FIG. 3 shows the timely evolution of the absolute angular position γ of disk 180 and camera 110, relative angular position α of mirror 130 towards optical axis O1 of camera 110, angular velocity Ω of disk 180 that is constant, angular velocity ω of mirror 130 actuated by second motor 140, and angular acceleration dω/dt of mirror 130. Three different time periods are represented on the abscissa, with time period T₁ where a single image is acquired by camera 110 during which time the relative angular position α is decreasing substantially linearly, time period T₂ during which the scanning mirror 130 is returned back to an initial angular position α₁ again. In the example shown, the initial angle α₁ is approximately 81°. Because during time period T₂ angle α of mirror 130 is not compensating rotation Ω, no image capturing or intergration is performed. Also, a time period T₃ is shown that is shorter than time period T₂ during which the relative angular position α is actually increased from a minimal value to a maximal value. To avoid that the relative angular position changes abruptly after time period T₁ and α₄, relative angular position α is still decreased to its minimal value, and then at time period T₃ the value is increased again.

Also, after relative angular position α has reached its maximal value with α₇, the time period T₁ for image integration and capture does not just start yet and relative angular position α is decreased first to avoid any abrupt changes in the relative angular position. With increasing time, absolute angular position γ of disk 180 and camera 110 linearly increases, showing the constant rotation of camera 110. As can be seen from the waveform representing relative angular position α, mirror 130 is not instantaneously snapped back to initial angle position α₁, but the relative angular velocity α follows a special waveform that allows to reduce the torque the second motor 140 has to provide for positioning mirror 130. From these waveforms it can also be seen that angular velocity ω of mirror 130 in time period T1 is approximately negative angular velocity −Ω of disk 180 within a certaing tolerance value of +ΔΩ/2 and −ΔΩ/2 actuated by second motor 140, and angular acceleration dΩ/dt of mirror never exceeds dω/dtmax.

Accordingly, for implementing the above described waveforms for relative angular position α, instead of using a sawtooth or pure triangular waveform as a set value for the relative angular position α that first linearly decreases from a maximal value to a minimal value and then jumps back instantaneously to its maximal value, it is possible to use a periodic waveform that is based on sine-waveforms that approximate an ideal triangular waveform to a certain degree. By using such a waveform, the frequency content of the waveform can be limited to lower-order harmonics. The waveform can be described by the following mathematical equation:

$$α ( t ) = {\sum }_{i = 1}^{m} C [ i ] \cdot sin [ 2 π it ( 2 m - 1 ) f ] \qquad Equation 1$$

in which t is the time, m is the waveform mode selector that can take any positive Integer value, f is the frequency of the waveform that will correspond to frame rate f of camera 110, and C[i] represents a set of coefficients that are determined below. To determine the values of C[i] a set of m equations is generated that is represented by the first m odd derivatives of α(t). The first derivative is set to be equal to 1, and all higher derivatives are set to zero.

$$( \begin{matrix}1 \\ 0 \\ 0 \\ ⋮ \\ ⋮ \\ ⋮ \\ 0\end{matrix} ) = ( \begin{matrix}\frac{d}{d t} α [ t ] \\ \frac{{d}^{3}}{d {t}^{3}} α [ t ] \\ \frac{{d}^{5}}{d {t}^{5}} α [ t ] \\ ⋮ \\ ⋮ \\ ⋮ \\ \frac{{d}^{( 2 m - 1 )}}{d {t}^{( 2 m - 1 )}} α [ t ]\end{matrix} ) {Limit}_{t -> 0} \qquad Equation 2$$

The resulting equations are all linear in C[i] with constant coefficients that are straightforward to solve. With a value 1 for m we receive a sine-waveform with the frequency f. In the limit that m becomes infinite the waveform takes the shape of a perfect triangular waveform. For values of m between 1 and infinite a family of waveforms are received that can be used as a set value for second motor 140 that do not produce any overshoot over the triangle waveform as an envelope. The set of C[i] values, also called Murray numbers, for m=1 and m=7 and frequency f=1 are as follows, where the sets are represented in rows, starting with i=1:

$$\begin{matrix} & 1 & 2 & 3 & 4 & 5 & 6 & 7 \\ 1 & \frac{1}{2 π} & & & & & & \\ 2 & \frac{2}{3 π} & - \frac{1}{12 π} & & & & & \\ 3 & \frac{3}{4 π} & - \frac{3}{20 π} & \frac{1}{60 π} & & & & \\ 4 & \frac{4}{5 π} & - \frac{1}{5 π} & \frac{4}{105 π} & - \frac{1}{280 π} & & & \\ 5 & \frac{5}{6 π} & - \frac{5}{21 π} & \frac{5}{84 π} & - \frac{5}{504 π} & \frac{1}{1260 π} & & \\ 6 & \frac{6}{7 π} & - \frac{15}{56 π} & \frac{5}{63 π} & - \frac{1}{56 π} & \frac{1}{385 π} & - \frac{1}{5544 π} & \\ 7 & \frac{7}{8 π} & - \frac{7}{24 π} & \frac{7}{72 π} & - \frac{7}{264 π} & \frac{7}{1320 π} & - \frac{7}{10296 π} & \frac{1}{24024 π}\end{matrix} \qquad Equation 3$$

A graphical representation of one period of the first i=20 modes is represented in FIG. 4. It can be seen that the family of waveforms for a have a relatively low frequency content with an increasing frequency with an increasing number of modes. For waveform mode m, signal amplitudes for frequency components that are higher than 2m−1 are all zero, and for frequencies below to cutoff, the roll off with higher frequency is relatively fast. The waveforms shown in FIG. 4 are not normalized for use to define a set value for relative angular position α as shown in FIG. 3, and to use such waveforms in an rotating optical assembly 100, the waveform would have to be shifted to fit the appropriate range of relative angular positions α, would have to be inverted, and the time basis would have to be adjusted appropriately. By using such waveform for relative angular position α, rapid changes in the position α can be avoided and high-frequency content can be avoided.

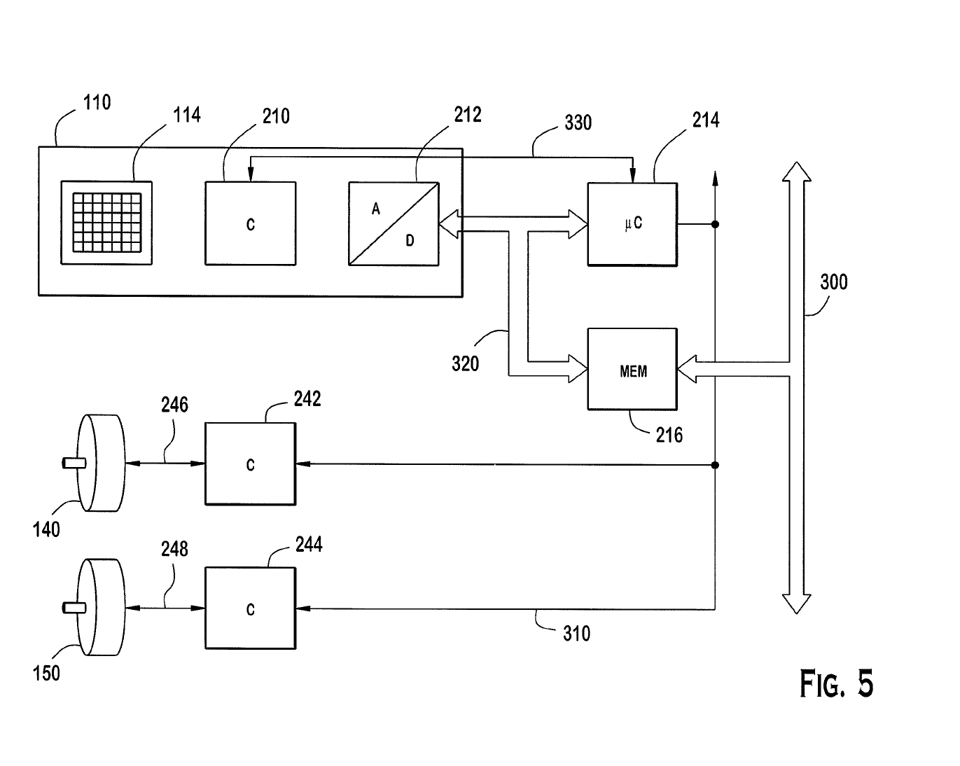

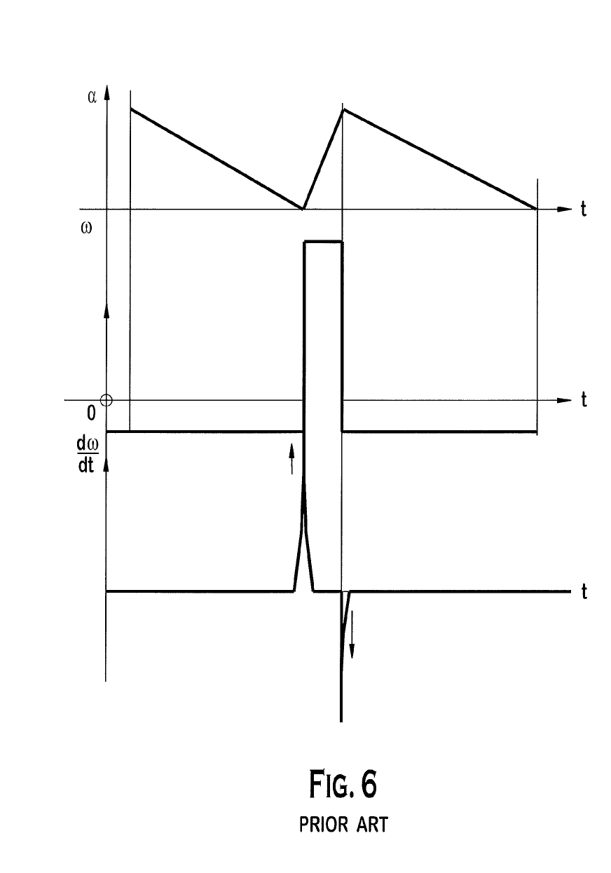

FIG. 5 is a schematic representation of a control system for the rotating optical assembly 100. Camera 110 is depicted in more detail with image sensor 114, image sensor controller 210, analog-to-digital converter 212. Moreover, camera 110 has a local data bus 320 that is connected to an external memory 216, and a system controller 214 that is configured to control the camera 110. Also, system controller 214 is also connected via a control bus 310 to a controller 244 for the first motor 150, and to a controller 242 or the second motor 140. Thereby, system controller 214 can have information on the rotational speed Ω of first motor 150 that rotates camera 110 and disk 180, and can also set the angular position α of second motor 140. Motor 140 provides, via local bus 246, information on the actual angular position α. It is also possible that a special stepper motor as a brushless DC electric motor that does not have a feed back of the actual positional angle, but that the angles can be directly set by controller 242. System controller 214 can use a look-up table or can also calculate relative angular position α for second motor 130, based on an image acquisition synchronization signal that can be generated by system controller 214 and that triggers the exact timing when an image is acquired by image sensor 114, so that the image acquisition period is in sync with period T₁ where relative angular position decreases quasi linearly.

While the invention has been described with respect to specific embodiments for complete and clear disclosures, the appended claims are not to be thus limited but are to be construed as embodying all modifications and alternative constructions that may occur to one of ordinary skill in the art which fairly fall within the basic teachings here set forth.

1. A scanning imaging apparatus comprising:
a rotatable support platform;
an imaging device that is attached to the support platform;
a mirror that is rotatably attached to the support platform and is configured to deflect an optical path of the imaging device;
a first motor configured to continuously rotate the rotatable support platform at a first angular velocity;
a second motor configured to change an angle of the mirror relative to an optical axis of the imaging device at a second relative angular velocity relative to the optical axis; and
a controller configured to control the angle of the mirror so that a waveform of the angle of the mirror as a function of time does not have high frequency components.

2. The scanning imaging apparatus according to claim 1, wherein
the waveform of the angle of the mirror does not have any frequency components that are above nine times the fundamental frequency.

3. A rotating camera system comprising:
a first motor;
a camera forming an optical axis, the camera being rotatable by the first motor;
a mirror arranged in a path formed by the optical axis configured to reflect the optical axis of the camera to form a reflected optical axis;
a second positional motor that is connected to mirror for changing a relative angle between the optical axis of the camera and the reflected optical axis;
a controller configured to control the relative angle so that a waveform of the relative angle as a function of time does not have high frequency components.

4. The rotating camera system according to claim 3, wherein
the waveform of the relative angle does not have any frequency components that are above nine times the fundamental frequency.
